(19) United States
(12) Patent Application Publication
(10) Pub. No.: US 2008/0092858 A1
(43) Pub. Date: Apr. 24, 2008

(54) FUEL VAPOR TREATMENT SYSTEM

(75) Inventors: Kazuki Satoh, Ichinomiya-city (JP); Toshiki Annoura, Nagoya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/873,730

(22) Filed: Oct. 17, 2007

(30) Foreign Application Priority Data
Oct. 18, 2006 (JP) 2006-284189

(51) Int. Cl. F02M 33/04

(52) U.S. Cl. 123/520

(57) ABSTRACT

A first fuel state determination section determines a fuel condition purged from a canister based on a quantity of deviations from a target air fuel ratio of the measured air-fuel-ratio. A second fuel state determination section determines a fuel condition after a purge control valve has closed. An abnormality detecting section detects an abnormalities of the second fuel state determination section. An air-fuel-ratio learning section performs air-fuel-ratio learning. An air-fuel-ratio-control section controls a fuel injection quantity based on the fuel condition. An initiation timing of the purge by a purge control valve is adjusted based on a history of an abnormality detection of the second fuel state determination section and a learning history of the air-fuel-ratio learning section. A fuel vapor treatment apparatus which can enlarge a purge amount enough is provided.

### CROSS-REFERENCE TO RELATED APPLICATION

This application is based on Japanese Patent Application No. 2006-284189 filed on Oct. 18, 2006, the disclosure of which is incorporated herein by reference.

### FIELD OF THE INVENTION

The present invention relates to a fuel vapor treatment system for an internal combustion engine.

### BACKGROUND OF THE INVENTION

The fuel vapor treatment system is for preventing fuel vapor in a fuel tank from diffusing to an atmosphere. The fuel vapor in the fuel tank is introduced into a canister which includes an adsorbing material therein. The canister adsorbs the fuel vapor temporarily. The fuel vapor adsorbed in the adsorbing material is desorbed by negative pressure in the intake pipe when the engine is driven. And the desorbed fuel vapor is purged into the intake pipe through a purge pipe. In this manner, when the fuel vapor is desorbed from the adsorbing material, the adsorbing capacity of the adsorbing material is recovered.

Also when purging the fuel vapor into the intake pipes it is necessary to control the air-fuel-ratio of the air-fuel mixture toward a target air fuel ratio (generally stoichiometric air fuel ratio). JP-7-269419A shows a system in which an air-fuel-ratio sensor is provided in an exhaust pipe and a feedback control of fuel injection is performed based on a deviation between the detected air-fuel-ratio and a target air-fuel-ratio so that the air fuel ratio is brought into the target air-fuel-ratio.

A concentration of an air-fuel mixture containing a fuel vapor which is purged from the canister is estimated based on the air-fuel-ratio deviation. A fuel injection quantity is controlled based on the concentration of the air-fuel mixture so that the air-fuel-ratio is brought into the target air-fuel-ratio.

However, in a method of estimating the air-fuel mixture concentration based on the air-fuel-ratio deviation during the purge, it is necessary to learn the deviation of the air-fuel-ratio before purging in order to except a deviation (tolerance) due to an individual specificity of the injectors. Therefore, in such a method, the purge cannot be performed until air-fuel-ratio learning is completed.

Moreover, it is required to perform purge sufficiently during engine operation. However, since there is a period of engine suspension also in driving by the hybrid vehicle, it may be difficult to perform sufficient purge. For this reason, it is necessary to increase the purge flow rate at the time of purge execution.

In a case that an air-fuel-ratio is actually measured by the air-uel sensor and the air-fuel-ratio deviation is fed back to determine a fuel injection quantity, if the fuel vapor is not purged, the fuel injection quantity cannot be determined. Therefore, at the time of the purge start, it is necessary to enlarge the purge rate gradually to such an extent that air fuel ratio fluctuation does not arise greatly. It is necessary to enlarge the purge rate gradually from the small value also at the time of the restart after purge suspension. Therefore, the purge quantity could not be enlarged enough.

### SUMMARY OF THE INVENTION

The present invention has been made in view of the above matters. An object of the present invention is to provide a fuel vapor treatment system for an internal combustion engine capable of increasing the purge quantity of the fuel vapor sufficiently.

According to the present invention, the fuel vapor treatment system includes a canister that temporarily adsorbs a fuel vapor developed in a fuel tank, a purge pipe that introduces the fuel vapor purged from the canister into an intake pipe, a purge control valve that is arranged in the purge pipe and controls a purge flow rate from the purge pipe to the intake pipe. An air-fuel-ratio sensor is provided in an exhaust pipe and measures an air-fuel-ratio.

A first fuel state determination means determines a state of fuel of an air-fuel mixture containing the fuel vapor purged from the canister on the basis of an amount of deviation from a target air-fuel-ratio of an air-fuel-ratio detected by the air-fuel-ratio sensor when the purge control valve is opened.

An air-fuel-ratio learning means performs an air-fuel-ratio learning for correcting an air-fuel-ratio deviation between an air-fuel-ratio detected by the air-fuel-ratio sensor and a target air fuel ratio when the purge control valve is closed.

An air-fuel-ratio control means controls a fuel injection quantity to the internal combustion engine, which is corrected based on a learning correction quantity determined by the air-fuel-ratio learning means, in such a manner as to bring an air-fuel-ratio to the target air-fuel-ratio on the basis of the state of fuel of the air-fuel mixture purged from the canister.

A second fuel state determination means determines the state of fuel of the air-fuel mixture purged from the canister when the purge control valve is closed.

An abnormality detection means detects abnormalities of the second fuel state determination means.

A first memory means stores a history of the abnormality detection of the second fuel state determination means by the abnormality detection means. A second memory means stores a learning history of air-fuel-ratio learning by the air-fuel-ratio learning means.

A purge timing variable means variably adjusts the start timing of the purge with the purge control valve based on the history of the abnormality detection of the second fuel state determination means and the learning history of the air-fuel-ratio learning means.

### BRIEF DESCRIPTION OF THE DRAWINGS

FIG. 1 is a construction diagram to show the construction of a fuel vapor treatment apparatus according to an embodiment of the present invention;

FIG. 2 is a flowchart to show an abnormality diagnosis control for diagnosing a leak and an abnormality in a fuel concentration detection system of a fuel vapor treatment apparatus;

FIG. 3 is a flowchart to show an abnormality diagnosis routine executed in step 24 in FIG. 2;

FIG. 4 is a diagram to show a state in which gas flows at the time of executing step 241 in FIG. 3;

FIG. 5 is a diagram to show a state in which gas flows at the time of executing step 247 in FIG. 3.

FIG. 6 is a flowchart to show a fuel concentration determination routine for determining a fuel vapor concentration in purge gas purged from a canister 13;

FIG. 7 is a flowchart to show a concentration detection routine for detecting a fuel concentration on the basis of pressure measurement;

FIG. 8 is a flowchart of an air-fuel-ratio control routine;

FIG. 9 is a flowchart of an air-fuel-ratio learning routine;

FIG. 10 is a flowchart of a purge ratio control routine;

FIG. 11 is a flowchart of a normal purge ratio control processing;

FIG. 12 is a flowchart of a normal purge ratio control processing executed in step 906 of the purge ratio control routine in FIG. 10;

FIG. 13 is a flowchart of a purge ratio initial value determination routine executed in step 9062 in FIG. 12;

FIG. 14 is a graph to show one example of a base flow rate;

FIG. 15 is a graph to show the relationship between a reference fuel concentration C and a ratio (Qc/Q100) of predicted flow rate Qc to a base flow rate Q100;

FIG. 16 is a graph to show the region of an air-fuel-ratio correction factor FAF;

FIG. 17 is a flowchart of processing of computing a purge ratio to be corrected at the time of restarting purge which is executed in step 909 of the purge ratio control routine in FIG. 10;

FIG. 18 is a flowchart of a purge valve driving routine;

FIG. 19 shows an example of a map for determining a fully open purge ratio;

FIG. 20 is a flowchart of a fuel concentration learning routine for computing a fuel concentration FGPG;

FIG. 21 is a flowchart of an injector control routine; and

FIG. 22 is a timing chart showing a purge timing.

### DETAILED DESCRIPTION OF THE PREFERRED EMBODIMENTS

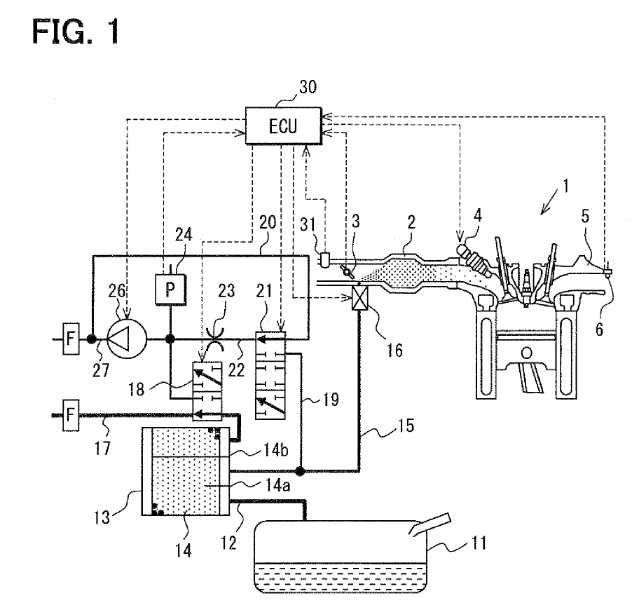

A preferred embodiment of the present invention will be described below. FIG. 1 is a construction diagram to show a construction of a fuel vapor treatment apparatus according to an embodiment of the present invention. A fuel tank 11 of an engine 1 is connected to a canister 13 via an evaporation line 12 of a vapor introduction passage.

The canister 13 is packed with an absorbing material 14 and temporarily absorbs the fuel vapor developed in the fuel tank 11 by the absorbing material 14. The canister 13 is connected to an intake pipe 2 of the engine 1 via a purge line 15 of a purge pipe. The purge line 15 is provided with a purge valve 16 of a purge control valve, and when the purge valve 16 is opened, the canister 13 communicates with the intake pipe 2.

The canister 13 includes partition plates 14a and 14b therein. A partition plate 14a is provided between a position where the evaporation line 12 is connected to the canister 13 and a position where the purge line 15 is connected to the canister 13, and prevents the fuel vapor introduced from the evaporation line 12 from being purged from the purge line 15 without being absorbed by the absorbing material 14.

The canister 13 has an atmosphere line 17 also connected thereto. A partition plate 14b which is nearly equal to the packing depth of the absorbing material 14 is provided between a position where the atmosphere line 17 is connected to the canister 13 and a position where the purge line 15 is connected to the canister 13 in the canister 13. With this, the partition plate 14b prevents the fuel vapor introduced from the evaporation line 12 from being purged from the atmosphere line 17.

The purge valve 16 is a solenoid valve and has its opening adjusted by an electronic control unit (ECU) 30 for controlling the respective parts of the engine 1. The air-fuel mixture flowing through the purge line 15 includes the purged fuel vapor. The flow rate of an air-fuel mixture flowing through the purge line 15 is controlled by the opening of the purge valve 16. This air-fuel mixture is purged into the intake pipe 2 by negative pressure developed in the intake pipe 2 by a throttle valve 3 and is combusted with fuel injected from an injector 4. The air-fuel mixture containing the purged fuel vapor is referred to as purge gas, hereinafter.

One end of an atmosphere line 17 is connected to the canister 13. The other end of the atmosphere line 17 communicates with the atmosphere via a filter. The atmosphere line 17 is provided with a switching valve 18 that makes the canister 13 communicate with the atmosphere line 17 or the suction side of a pump 26. When the switching valve 18 is not driven by the ECU 30, the switching valve 18 is at a first position where the canister 13 communicates with the atmosphere line 17 and when the switching valve 18 is driven by the ECU 30, the switching valve 18 is switched to a second position where the canister 13 communicates with the suction side of the pump 26.

A branch line 19 branched from the purge line 15 is connected to one input port of a three-way position valve 21. An air supply line 20 branched from a discharge line 27 of the pump 26, opened to the atmosphere via a filter, is connected to the other input port of the three-way valve 21. A measurement line 22 of a measurement passage is connected to the output port of the three-way valve 21. The three-way valve 21 is switched by the ECU 30 to any one of the first position where the air supply line 20 is connected to the measurement line 22, a second position where the communication of the measurement line 22 with both of the air supply line 20 and the branch line 19 is interrupted, and a third position where the branch line 19 is connected to the measurement line 22. Here, when the three-way position valve 21 is not operated, the three-way position valve 21 is constructed so as to be set at the first position.

The measurement line 22 is provided with an orifice 23 and the pump 26. The pump 26 is an electrically operated pump. When the pump 26 is operated, the pump 26 introduces gas into the measurement line 22 through the orifice 23. The revolution of the pump 26 is controlled by the ECU 30. The pump is driven at a constant speed.

When the ECU 30 operates the pump 26 the three-way position valve 21 is at the first position and the switching valve 18 is held at the first position, the measurement line 22 is brought to a first state of measurement in which air flows through the line 22. Moreover, when the ECU 30 operates the pump 26 and the three-way position valve 21 is brought to the third position, the measurement line 22 is brought to a second state of measurement in which an air-fuel mixture containing the fuel vapor flows through the line 22 through the atmosphere line 17, the canister 13, the purge line 15, and the branch line 19.

Moreover, a pressure sensor 24 is connected to the downstream of the orifice 23, that is, a portion between the orifice 23 and the pump 26. The pressure sensor 24 can detect a differential pressure between the atmospheric pressure and pressure on the downstream side of the orifice 23 of the measurement line 22. A pressure signal of the pressure sensor 24 is outputted to the ECU 30.

The ECU 30 controls the opening of the throttle valve 3 for adjusting an intake air volume, a fuel injection quantity from the injector 4, the opening of the purge valve 16, and the like on the basis of the detection values detected by various sensors. For example, the ECU 30 controls the above quantity on the basis of an intake air volume detected by an air flow sensor (not shown) provided in the intake pipe 2 and an intake air pressure detected by an intake air pressure sensor (not shown), an air-fuel-ratio detected by an air-fuel-ratio sensor 6 provided in an exhaust pipe 5, an ignition signal, an engine speed, an engine cooling water temperature, an accelerator position, and the like.

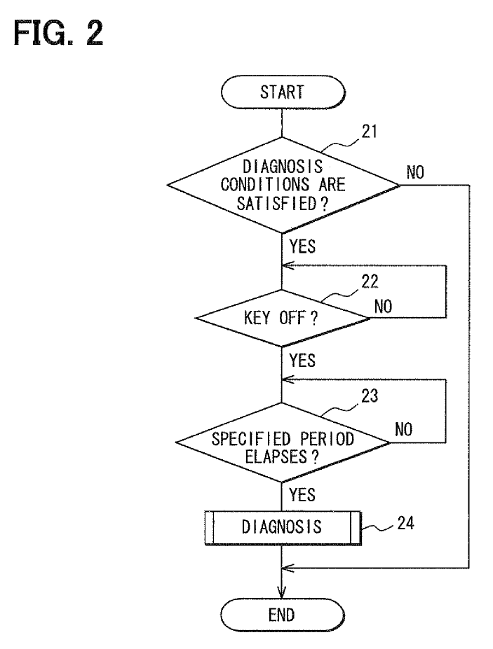

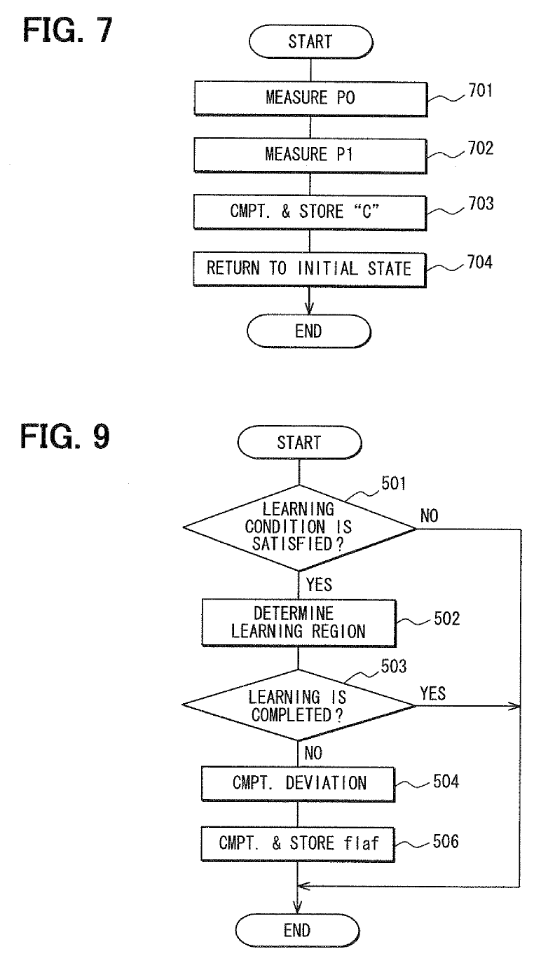

FIG. 2 is a flowchart to show abnormality diagnosis control for making a diagnosis of a leak and an abnormality of a fuel concentration detection system of a fuel vapor treatment apparatus. Here, the fuel concentration detection system includes is paths and devices through which gas passes. A fuel concentration detection routine shown in FIG. 7 is executed in this fuel concentration detection system.

In step 21, it is determined whether or not abnormality diagnosis conditions are satisfied. It is assumed that the abnormality diagnosis conditions (that is, leak diagnosis conditions) are satisfied when the time during which the vehicle is operated continues for a specified period of time or more or when outside temperature is a specified temperature or more. When determination in step 21 is negative, this routine is finished. When determination in step 21 is affirmative, it is determined in step 22 whether or not the key is OFF. When determination in step 22 is negative, step 22 is repeated to wait for the key to be turned OFF.

When determination in step 22 is affirmative, the routine proceeds to step 23 in which it is determined whether or not a specified period of time elapses from the time when the key is turned OFF. Step 23 is the processing of preventing making a diagnosis immediately after the key is turned OFF because immediately after the key is turned OFF, the pressure in the fuel vapor treatment apparatus is unstable and the fuel in the fuel tank 11 is swung or the fuel temperature is unstable. Hence it is not suitable to make a diagnosis of a leak and an abnormality. The specified period of time is a period of time, which elapses after the state in the fuel vapor treatment apparatus becomes unstable immediately after the key is turned OFF until the state become as stable as a leak diagnosis can be made correctly, and is previously set. When determination in step 23 is negative, step 23 is repeated, and when determination in step 23 becomes affirmative after the specified time elapses, a diagnosis of an abnormality is made in step 24 and then this routine is finished.

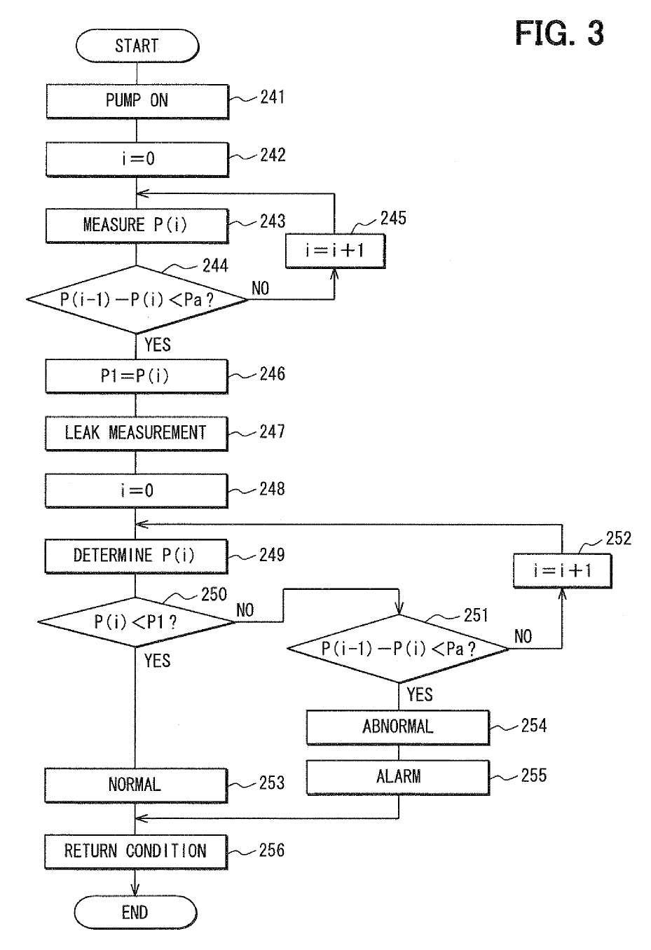

FIG. 3 shows an abnormality diagnosis routine. When the abnormality diagnosis routine is started, the three-position valve 21 is set at the first position and the switching valve 18 is also set at the first position. At this time, pressure detected by the pressure sensor 24 of a differential pressure sensor is 0.

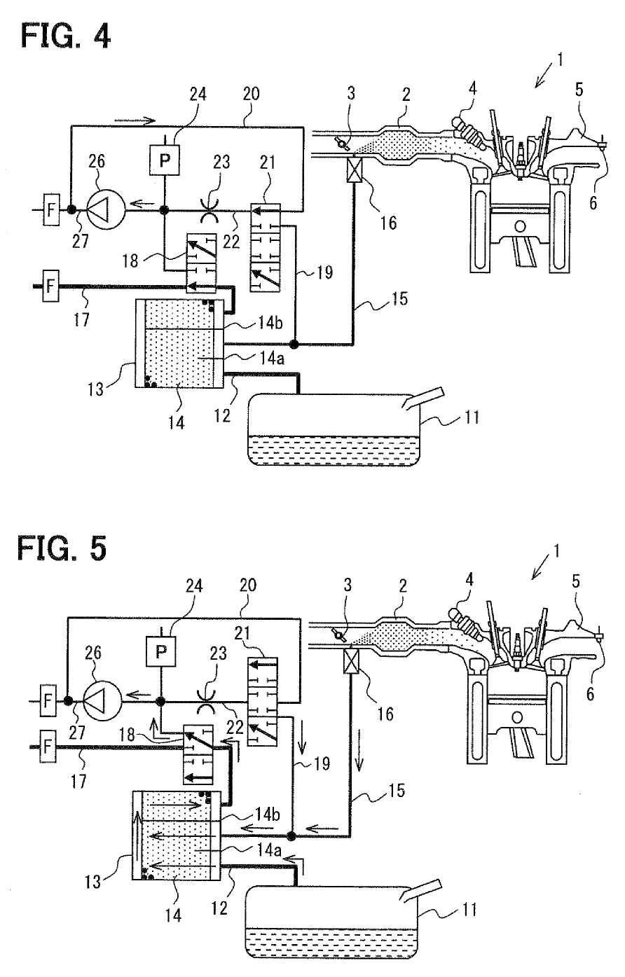

In step 241, the pump 26 is operated. The state of flow of the gas is shown in FIG. 4. The state shown in FIG. 4 is the same as the above-mentioned first measurement state. As shown in FIG. 4, in the state in step 241, the three-position valve 21 is set at the first position, so the air supply line 20 communicating with the atmosphere communicates with the measurement line 22 and the switching valve 18 is set at the first position, so the canister 13 does not communicate with the pump 26. Hence, the state in step 241 is an air flow state in which air passes through the measurement line 22 and hence the pressure detected by the pressure sensor 24 is a pressure drop of air by the orifice 23.

In step 242, a variable “i” is set at 0, and in the subsequent step 243, the pressure detected by the pressure sensor 24 is measured as pressure P(i). In step 244, a change (P(i−1)−P(i)) from the last measured pressure P(i−1) to this measured pressure P(i) is compared with a threshold Pa and it is determined whether or not (P(i−1)−P(i))<Pa.

When determination in step 244 is negative, the variable “i” is increased by 1 and the routine returns to step 243. When determination in step 244 is affirmative, and the routine proceeds to step 246. That is, the measured pressure shows a behavior that changes greatly when the pump 26 starts to operate and then converges gradually on a pressure value determined by the passage sectional area of the orifice 23 and the like, so processing following step 246 is executed after the measured pressure converges sufficiently.

In step 246, P(i) is substituted for the reference pressure P1. Then, in step 247, the state of measurement is switched to the state of leak measurement. This state of leak measurement is the state, shown in FIG. 5, in which the three-position valve 21 is set at the second position and in which the switching valve 18 is set at the second position. Here, when an abnormality diagnosis is conducted, the key is OFF and hence also the purge valve 16 is closed.

In this state of leak measurement, the fuel tank 11, the evaporator line 12, the canister 13, the purge line 15, the branch line 19, and a passage from the canister 13 to the pump 26 via the switching valve 18 constructs a closed space. For this reason, gas in the closed space is dissipated to the atmosphere by the pump 26, whereby pressure in the closed space is decreased.

Steps 248 to 255 are processing for determining the presence or absence of abnormalities in the closed space by comparing the measured pressure with the reference pressure P1. The abnormalities in the closed space include not only an abnormality that a leak aperture is formed in the closed space, that is, an abnormality in the line included in the closed space but also an abnormality of the other devices included in the closed space, for example, the faulty switching of the three-position valve 21 and the switching valve 18. This is because if an abnormality is not in the closed space, pressure on which pressure in the closed space in a state in which pressure is reduced converges is determined by the area of the aperture of the restrictor 23, but because if a leak aperture is formed in the closed space or a faulty switching of the three-position valve 21 or the switching valve 18 occurs, a completely closed space is not formed and hence the pressure does not reach the reference pressure P1.

In step 248, the variable “i” is set at 0. In step 249, the pressure P(i) is measured and in step 250, the measured pressure P(i) is compared with the reference pressure P1 and it is determined whether or not P(i)<P1. When this determination is affirmative, the routine proceeds to step 253, and when the determination is negative, the routine proceeds to step 254. At the beginning when the state of measurement is switched to the state of leak measurement, normally, the measured pressure P(i) does not reach the reference pressure P1 and hence determination in step 250 is negative.

When determination in step 250 is negative, the routine proceeds to step 251. Steps 251, 252 are processing of the same purport as steps 244, 245. In step 251, a change (P(i−1)−P(i)) from the last measured pressure P(i−1) to this measured pressure P(i) is compared with a threshold Pa and it is determined whether or not (P(i−1)−P(i))<Pa. When determination in step 251 is negative, the variable “i” is increased by “1” in step 252 and the routine returns to step 249. When the determination in step 251 is affirmative, the routine proceeds to step 254. The purport of step 251 is to wait the measured pressure P(i) to converge as in the case of the above-mentioned step 244.

In step 253, it is determined that the closed space is normal. And this normal determination is stored in RAM (not shown) of ECU30. In step 254, it is determined that the closed space is abnormal. And this abnormality determination is stored in the RAM. When a leak aperture larger than the orifice 23 exists in the closed space, it is determined that the closed space is abnormal. However, not only in the case where a leak aperture larger than the restrictor 23 exists in the closed space but also in the case where the closed space is not formed by the faulty switching of the three-position valve 21 and the switching valve 18, it is determined that the closed space is abnormal.

When step 253 is executed and it is determined that the closed space is normal, the routine proceeds to step 256. On the other hand, when step 254 is executed and it is determined that the closed space is abnormal, step 255 for operating alarm means is executed and then the routine proceeds to step 256. The alarm means is, for example, an indicator provided on the instrument panel of the vehicle.

In step 256, the pump 26 is stopped and both of the three-position valve 21 and the switching valve 18 are set at the first positions to return the operation to a state before making an abnormality diagnosis.

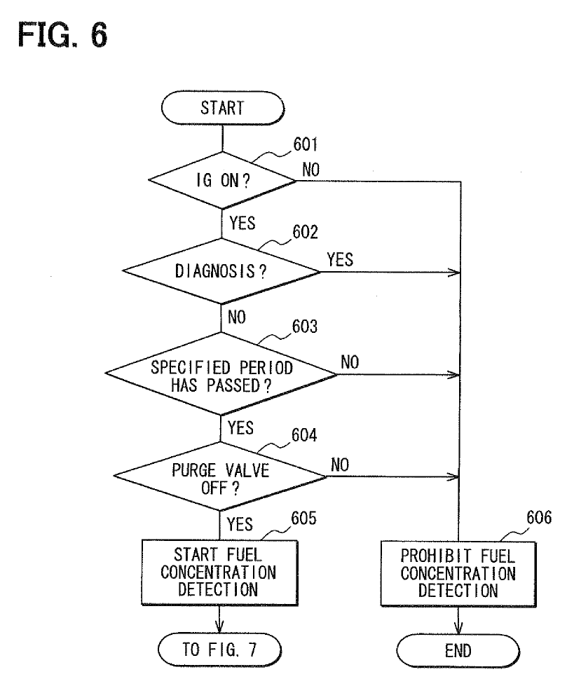

FIG. 6 is a flowchart to show a fuel concentration determination routine for determining a fuel vapor concentration in purge gas purged from the canister 13 and the fuel concentration determination routine is executed at intervals of a specified short period.

In step 601, it is determined whether or not an ignition switch is ON. When this determination is negative, the engine 1 is not started and purge control is not performed either, so it is determined in step 606 that the detection of concentration based on pressure measurement is prohibited and this routine is finished.

On the other hand, when determination in step 601 is affirmative, step 602 is executed to further determine whether or not it is determined in the above-mentioned abnormality diagnosis control (FIG. 2) that the fuel concentration detection system is abnormal. When determination in this step 602 is affirmative, that is, when an abnormality is detected in the closed space shown in FIG. 5, step 606 is executed to prohibit the detection of fuel concentration based on pressure measurement (FIG. 7).

This is because a pressure drop by the orifice 23 of the air-fuel mixture (pressure P1 of the air-fuel mixture flow) purged from the canister 13 is measured in step 702 in FIG. 7. For this reason, the purge valve 16 is closed in step 702 in FIG. 7, but when a leak aperture is formed in the evaporation line 15 and in the branch line 19, outside air flows into from the leak aperture to decrease the fuel concentration of the air-fuel mixture, thereby making it difficult to detect the correct fuel concentration. Moreover, also when the three-position valve 21 is not switched correctly and the air-fuel mixture is not introduced correctly into the orifice 23 and hence an abnormality is detected in the closed space, there is a high possibility that the pressure P1 of the air-fuel mixture flow in step 702 cannot be measured correctly. Hence, the detection of fuel concentration (FIG. 7) based on pressure measurement is prohibited.

When determination in step 602 is negative, that is, when it is diagnosed that the fuel concentration detection system is normal, the routine proceeds to step 603. In step 603, it is further determined whether or not the time that elapses after the last detection of fuel concentration based on pressure measurement, that is, the detection of fuel concentration (FIG. 7) is a specified period of time or more. When determination in step 603 is negative, the above-mentioned step 606 is executed.

When determination in step 603 is affirmative, it is further determined in step 604 whether or not the purge valve 16 is turned off, that is, is totally closed. Also when determination in this step 604 is negative, that is, also when the purge valve 16 is opened, the above-mentioned step 606 is executed.

When determination in step 604 is affirmative, it is determined in step 605 that the detection of fuel concentration based on pressure measurement is started, and the routine proceeds to a fuel concentration detection routine shown in FIG. 7.

FIG. 7 is a flowchart to show a fuel concentration detection routine for determining a fuel concentration based on pressure measurement. Here, before executing this fuel concentration determination routine, the purge valve 16 is closed and the switching valve 18 is set at the first position in which the canister is made to communicate with the atmosphere line 17 and the three-position valve 21 is set at the first position in which the air supply line 20 is connected to the measurement line 22. For this reason, in the initial state, pressure detected by the pressure sensor 24 is nearly equal to the atmospheric pressure.

In step 701, pressure P0 is measured by the pressure sensor 24 in a state in which air flows as a gas flow through the measurement line 22. This state corresponds to “a first state of measurement”. The measurement of the pressure P0 by an air flow is performed by operating the pump 26 with the three-position valve 21 held set at the first position. In this case, air is supplied to the measurement line 22 via the air supply line 20. Pressure on the upstream side of the orifice 23 of the air supply line 20 is the same as pressure at one end of the pressure sensor 24, and the other end of the pressure sensor 24 is connected to the downstream side of the orifice 23 of the air supply line 20, so a pressure drop when air passes through the orifice 23 is detected by the pressure sensor 24a.

Next, in step 402, pressure P1 is measured in a state in which the air-fuel mixture containing the fuel vapor is flowed as a gas flow through the measurement line 22. This state corresponds to “a second state of measurement”. The measurement of the pressure P1 by using the air-fuel mixture flow is performed by operating the pump 26 with the three-position valve 21 being switched to the third position. In this case, the air-fuel mixture containing the fuel vapor supplied via the atmosphere line 17, the canister 13, a portion of the purge line 15 to the branch line 19, and the branch line 19 is supplied to the measurement line 22. That is, air introduced from the atmosphere line 17 flows through the canister 13 and is mixed with the fuel vapor, thereby being brought to the air-fuel mixture of the fuel vapor and air. Then the air-fuel mixture is supplied to the measurement line 22 via the portion of the purge line 15 and the branch line 19. Thus, when pressure by the air-fuel mixture is measured, a pressure drop when the air-fuel mixture containing the fuel vapor is passed through the orifice 23 of the measurement line 22 is detected by the pressure sensor 24.

In step 703, a fuel concentration C is computed on the basis of pressures P0 and P1 which are measured in step 701 and step 702 and is stored in the ECU 30.

In the computation of the fuel concentration C, a pressure ratio RP between the pressure P0 and the pressure P1 is computed by equation (1) and the fuel concentration C is computed by equation (2) on the basis of the pressure ratio RP. In the equation (2), k1 is a constant determined suitably in advance by an experiment or the like.
RP=P1/P0 (1)
C=k1×(RP−1) (=(P1−P0)/P0) (2)

The fuel vapor is heavier than air, so when purge gas contains the fuel vapor, its density becomes higher. If the number of revolutions of the pump 26 is the same and the velocity of flow (flow rate) in the measurement line 2 is the same, according to the law of energy conservation, as density becomes higher, a differential pressure across the orifice 23 becomes larger. Hence, as the fuel concentration C becomes larger, the pressure ratio RP becomes larger, and the relationship between the fuel concentration C and the pressure ratio RP becomes a linear relationship as shown by equation (2). Here, the fuel concentration C computed in this manner expresses the concentration of the fuel vapor in the purge gas by a mass ratio.

In the next step 704, the respective parts are returned to the initial states. That is, the switching valve 18 is returned to the first position in which the canister 13 communicates with the atmosphere line 17 and the three-position valve 21 is returned to the first position where the air supply line 20 is connected to the measurement line 22.

FIG. 2 is a flowchart of an air-fuel-ratio control routine that is executed at intervals of a specified cam angle.

In step 801, it is determined whether or not an air-fuel-ratio feedback control is allowed. That is, when all of the following conditions that:

(1) operation is not at the startup;

(2) fuel cut is not in the course of being performed;

(3) cooling water temperature (THW) 40 C.°; and

(4) air-fuel-ratio sensor is completely activated, are satisfied, an air-fuel-ratio feedback control is allowed. If any one of the above-mentioned conditions is not satisfied, the air-fuel-ratio feedback control is not allowed.

When determination in step 801 is affirmative, the routine proceeds to step 802. In step 802, an output voltage Vox of the air-fuel-ratio sensor 6 is read. In step 803, it is determined whether or not the output voltage VOX is a specified reference voltage VR (for example, 0.45 V) or less. When determination in step 803 is affirmative, it is assumed that the air-fuel-ratio of exhaust gas is lean and the routine proceeds to step 804 in which an air-fuel-ratio flag XOX is set at “0”.

Next, in step 805, it is determined whether not the air-fuel-ratio flag XOX is identical to a state holding flag XOXO. When determination in step 805 is affirmative, it is assumed that a lean state continues and, in step 806, an air-fuel-ratio correction factor FAF is increased by a lean integrated amount “a” and this routine is finished. On the other hand, when determination in step 805 is negative, it is assumed that a rich state is reversed to a lean state and the routine proceeds to step 807 in which the air-fuel-ratio correction factor FAF is increased by a lean skip amount “A”. Here, the lean skip amount “A” is set at a sufficiently large value as compared with the lean integrated amount “a”. Then, the routine proceeds step 808 in which the state holding flag XOXO is reset and then this routine is finished.

When determination in step 803 is negative, it is assumed that the air-fuel-ratio of exhaust gas is rich and the routine proceeds to step 809 in which the air-fuel-ratio flag XOX is set at “1”. Then, in step 810, it is determined whether not the air-fuel-ratio flag XOX is identical to a state holding flag XOXO. When determination in step 810 is affirmative, it is assumed that a rich state continues and, in step 811, the air-fuel-ratio correction factor FAF is decreased by a rich integrated amount “b” and this routine is finished. On the other hand, when determination in step 810 is negative, it is assumed that a lean state is reversed to a rich state and the routine proceeds to step 812 in which the air-fuel-ratio correction factor FAF is decreased by a rich skip amount “B”. Here, the rich skip amount “B” is set at a sufficiently large value as compared with the rich integrated amount “b”.

Next, in step 813, the state holding flag XOXO is set at “b” and then this routine is finished. Here, when determination in step 801 is affirmative, the routine proceeds to step 814 in which the air-fuel-ratio correction factor FAF is set at “1.0” and then this routine is finished.

FIG. 9 is a flowchart of the air-fuel-ratio learning routine. In step 501, it is determined whether the start condition of air-fuel-ratio learning is satisfied. This air-fuel-ratio learning start condition includes above F/B conditions, a circulating-water-temperature conditions (THW>80° C.), and a concentration detection completion conditions (concentration detection completion flag XIPRGHC=1).

When the affirmative determination is performed in step 501, the processing is advanced to step 502. When the negative determination is performed in step 501, this routine is ended. When the answer is Yes in step 501, the procedure proceeds to step 502 and it is determined in which learning region the present operational status is. That is, in step 502, an intake air quantity, an engine load, and engine speed are read, and it is determined in which learning region the present operational status is. Then, the procedure proceeds to step 503 in which it is determined whether the air-fuel-ratio learning in the determined learning region is completed. When the answer is No in step 503, the procedure proceeds to steps 504 and 506 in which the air-fuel-ratio learning is performed. When the answer is Yes in step 503, this routine is ended.

The operational status is divided into a plurality of regions based on the engine load, the air-fuel-ratio learning “flaf” is given for every divided learning region, the air-fuel-ratio learning is performed for every learning region, and the “flaf” is updated.

In step 504, the deviation between the air-fuel-ratio detected by the air-fuel-ratio sensor 6 and target air fuel ratio (stoichiometric air fuel ratio) is computed. In step 506, while computing the learning correction value “flaf” for correcting the quantity of air-fuel-ratio deviations computed in step 504, this learning correction value “flaf” is stored in the ECU 30.

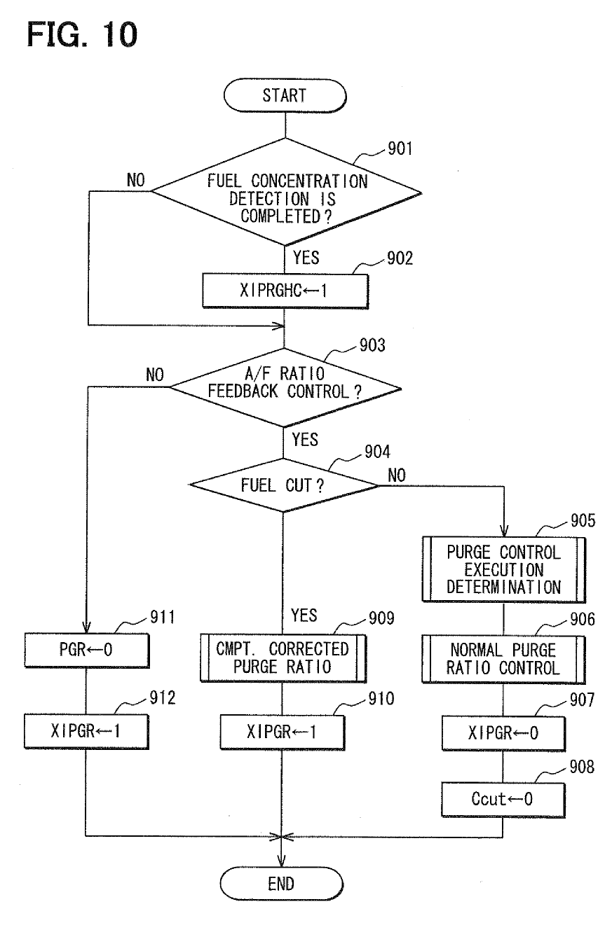

FIG. 10 is a flowchart of a purge ratio control routine. In step 901, it is determined whether or not the detection of fuel concentration based on the pressure measurement shown in FIG. 7 is completed. When determination in step 901 is affirmative, a pressure concentration detection completion flag XIPRGHC is set at 1 in step 902, and then step 903 is executed. On the other hand, when determination in step 901 is negative, the processing of step 903 is directly executed.

In step 903, it is determined whether or not air-fuel-ratio feedback control is being performed. When determination in step 903 is affirmative, the routine proceeds to step 904 in which it is determined whether or not fuel cut is performed.

When determination in step 904 is negative, the routine proceeds to step 505 in which it is determined whether the purge control can be performed. When the purge control can be performed, the procedure proceeds to step 906. In step 906, a normal purge ratio control is performed. And then the routine proceeds to step 907. In step 907, a purge stop flag XIPGR is reset (set at 0) and a fuel cut counter Ccut is reset in step 908 and this routine is finished.

When determination in step 904 is affirmative, the routine proceeds to step 909 in which a purge ratio to be corrected at the time of restarting purge is computed, and then the purge stop flag XIPRG is set at “1” in step 910, and this routine is finished.

Moreover, when determination in step 903 is negative, the routine proceeds to step 911 in which a purge ratio PGR is reset (set at 0), and then in step 912, the purge stop flag XIPGR is set at “1” and this routine is finished.

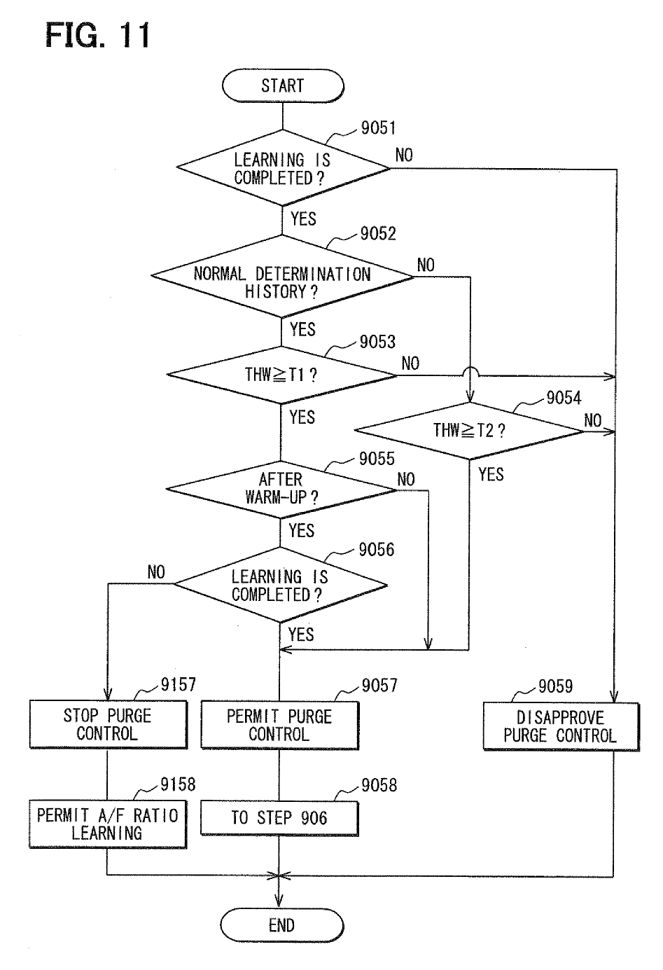

FIG. 11 is a flowchart showing a purge control execution determination routine which is performed in step 905. In step 9051, it is determined whether air-fuel-ratio learning is completed in the learning region corresponding to the present operational status. When the affirmative determination is performed in step 9051, the processing is advanced to step 9052. When the negative determination is performed in step 9051, the processing is advanced to step 9059 in which the purge control execution is disapproved.

When the answer is Yes in step 9051, the learning correction value “flaf” over the learning region is stored in step 506. Therefore, in step 9051, when air-fuel-ratio learning is completed on this trip, the affirmative determination is performed in a case where there is history that the completion of air-fuel-ratio learning was performed on the past trip which contains the trip last time is performed.

Even if the air-fuel-ratio learning start condition is not satisfied immediately after engine start up, the start timing of purge control execution shown in FIG. 10 is brought forward using the learning correction value “flaf” stored in the ECU 30 based on the history showing the completion of air-fuel-ratio learning in the learning region.

In step 9052, it is determined whether there is any normal determination history that normal determination was performed in the abnormality diagnosis of the evaporation fuel processing unit. That is, it is determined whether it is a normal result in checking the leakage of the evaporation fuel processing unit and the abnormalities of the fuel concentration detection system by the abnormality diagnosis shown in of FIG. 2. When the affirmative determination is performed in step 9052, the procedure proceeds to step 9053 in which a first purge start condition determination process is executed. When the negative determination is performed at step 9052, the procedure proceeds to step 9054 in which a second purge start condition determination process is executed.

When abnormality diagnosis is not completed (it contains also when not performing), or when it determined that there is abnormality, it does not become the normal determination history. Hence, the determination process in step 9059 is prohibited and the determination process in step 9054 is performed.

In step 9053, it is determined whether the engine cooling water temperature THW is greater than or equal to T1 (THW>=T1), which is a first purge start condition. When the affirmation determination is performed, the procedure will proceed to step 9057 in which the purge control is permitted. When the negative determination is performed, the procedure will proceed to step 9059 in which the purge control execution is disapproved.

Moreover, it is determined whether the engine cooling water temperature THW is greater than or equal to T2 (THW>T2), which is a second purge start condition. When the affirmation determination is performed, the procedure proceeds to step 9057 in which the purge control execution is permitted. When the negative determination is performed, the procedure proceeds to step 9059 in which the purge control execution is disapproval.

In the present embodiment, T2 is greater than T1. Specifically, T1=40° C. and T2=80° C. In the first purge start condition, THW=40° C. which is the same as the FIB conditions. In the second purge start condition, THW=80° C. which is the same as the air-fuel-ratio learning start condition.

In addition, the driving condition in which the engine cooling water temperature THW is T1 (40° C.) represents a condition in which the engine has been just cold-started. In the cold-start condition, the coolant temperature THW is relatively low, compared with the driving condition after warming-up.

Here, while being in the driving condition (THW≧T1) after cold-start, the purge control execution is repeatedly performed by the decision processing in step 9053. However, there is a possibility that the purge control reflecting the air-fuel-ratio learning history in the last trip is performed, and the air-fuel-ratio learning on this trip has not been performed yet. For this reason, when air-fuel-ratio learning has not been performed on this trip, the purge is stopped compulsorily and the air-fuel-ratio learning of FIG. 9 is performed in steps 9157 and 9158.

In step 9055, it is determined whether it is in the condition after warming-up of the engine. When the affirmation determination is performed in step 9055, it is further determined whether the air-fuel-ratio learning is completed on this trip in step 9056. When the affirmation determination is performed in step 9056, the process proceeds to step 9057.

When the negative determination is performed in step 9056, it is determined that the purge control is compulsorily stopped in step 9157 so that the purge control execution is disapproved. Then, the procedure proceeds to step 9158 in which the air-fuel-ratio learning is permitted.

When the purge control execution permission is determined in step 9057, the procedure proceeds to step 9058. In step 9058, the procedure proceeds to step 906 shown in FIG. 10. On the other hand, when the purge control execution disapproval is determined in step 9059, this routine is ended without progressing to step 905 in FIG. 10. Moreover, when it is determined that the purge control execution is compulsorily stopped in step 9157 and the air-fuel-ratio learning is permitted in step 9158, this routine is ended without progressing to step 906 of FIG. 10.

Besides, the condition after warming-up of the above-mentioned engine is in the condition that the air-fuel-ratio learning start condition is satisfied, and the engine cooling water temperature THW set to THW≧80° C. (T2=80° C.).

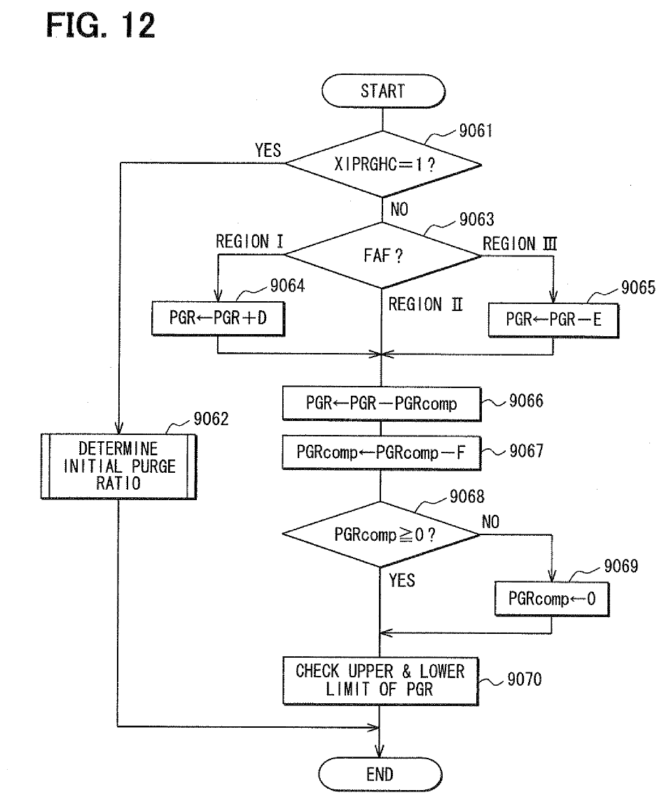

FIG. 12 is a flowchart of normal purge ratio control processing executed in step 906 of the purge ratio control routine shown in FIG. 10. First, in step 9061, it is determined whether or not the pressure concentration detection completion flag XIPRGHC is 1. When this determination is affirmative, a purge ratio initial value determination routine is executed in step 9062.

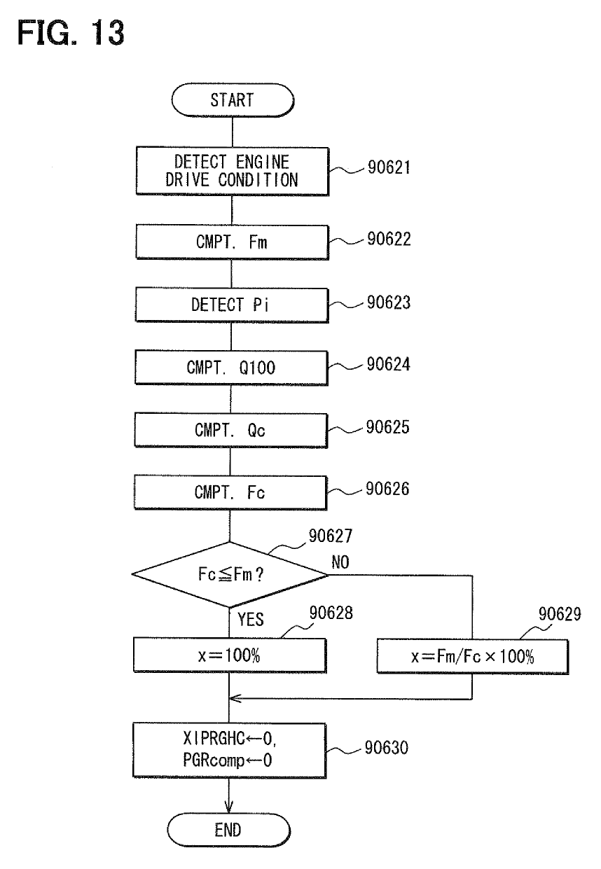

The purge ratio initial value determination routine is shown in detail in FIG. 13. First, in steps 90621 and 90622, an allowable upper limit of a purge flow rate is set. That is, in step 90621, the operating state of the engine is detected, and in step 90622 the allowance of flow rate of allowable purge fuel vapor Fm is computed on the basis of the detected operating state of the engine. The allowance of flow rate of purge fuel vapor Fm is computed on the basis the fuel injection quantity required in the operating state of the engine such as a present throttle opening, a lower limit of fuel injection quantity to be controlled by the injector 4, and the like. As the fuel injection quantity becomes larger, the ratio of the flow rate of purge fuel vapor to the fuel injection quantity becomes smaller, so also the allowance of flow rate of purge fuel vapor Fm can be allowed to a large value.

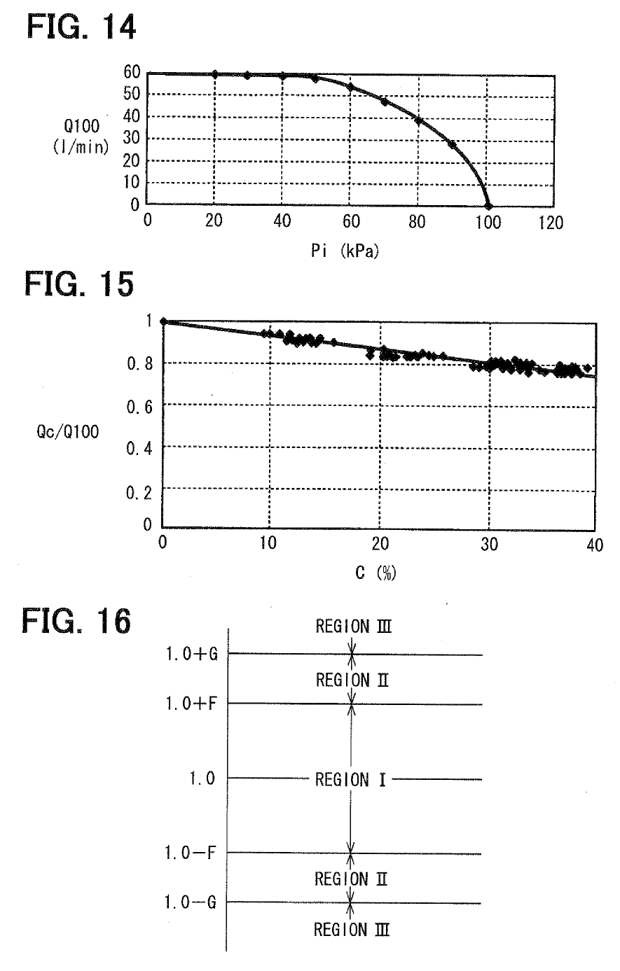

In step 90623, the present intake pipe pressure Pi is detected by an intake air pressure sensor (not shown) and in step 90624, a base flow rate Q100 is computed on the basis of the intake pipe pressure Pi. The base flow rate Q100 is the flow rate of gas of 100% air flowing in the purge line 15 when the opening of the purge valve 16 (hereinafter referred to as “purge valve opening”) is 100%, and is computed according to a base flow rate map. In FIG. 14, an example of the base flow rate map is shown.

In step 90625, a predicted flow rate Qc of a purge air-fuel mixture is computed by a following equation (3) on the basis of the fuel concentration C detected by the fuel concentration detection routine (FIG. 7). The predicted flow rate Qc is the predicted value of purge gas flow rate when purge gas of the present fuel concentration C is flowed in the purge line 15 with the opening of the purge value set at 100%. FIG. 15 is a graph to show the relationship between fuel concentration C and the ratio (Qc/Q100) of the predicted flow rate Qc to the base flow rate Q100. As the fuel concentration C becomes larger, the density of purge gas becomes larger, so even if the intake pipe pressure Pi is the same, the flow rate becomes smaller than when purge gas is 100% air by the law of energy conservation. A straight line in the drawing is equivalent to equation (3). In the equation (3), “A” is a constant and is previously stored with control programs in the ROM of the ECU 30.
Qc=Q100×(1−AxC) (3)

In step 90626, the predicted flow rate of purge fuel vapor (hereinafter, referred to as “Predicted flow rate of purge fuel vapor”) Fc when purge gas of the present fuel concentration C is flowed in the purge line 15 with the opening of the purge valve set at 100% is computed by equation (4) on the basis of the fuel concentration C and the predicted flow rate Qc.
Fc=Qcx (4)

In steps 90627 to 90629, a purge valve opening “x” is set. In step 90627, the predicted flow rate of purge fuel vapor Fc is compared with the allowance of flow rate of purge fuel vapor Fm and it is determined whether or not Fc≦Fm. When determination is affirmative, the routine proceeds to step 90628 in which the purge valve opening x is set at 100%. This is because even if the purge valve opening x is set at 100%, there is a room for the allowance of flow rate of purge fuel vapor Fm. When determination in step 90627 in which it is determined whether not FC≦Fm is negative, it is determined that when the purge valve opening x is 100%, air-fuel-ratio control cannot be normally performed because of excessive fuel vapor and the routine proceeds to step 90629 in which the purge valve opening x is set at (Fm/Fc)×100%. This is because when FC>Fm, the maximum value of purge flow rate that guarantees proper air-fuel-ratio control becomes the allowance of flow rate of purge fuel vapor Fm.

When the purge valve opening x is computed in steps 90628 and 90629, the purge valve 16 is controlled to the computed opening.

After executing steps 90628 and 90629, in step 90630, the pressure concentration detection completion flag XIPRGHC is reset (set at 0) and a purge ratio PGRcomp to be corrected at the time of restarting purge is set at 0. By resetting the pressure concentration detection completion flag XIPRGHC in step 90630, determination in step 9061 in FIG. 12 becomes negative thereafter, so steps following step 9063 are executed.

In step 9063, it is determined which region the air-fuel-ratio correction factor FAF belongs to. FIG. 16 is a graph to show the region of the air-fuel-ratio correction factor FAF. It is determined as follows: when the air-fuel-ratio correction factor FAF is within 1±F, the air-fuel-ratio correction factor FAF belongs to a region I; when the air-fuel-ratio correction factor FAF is between 1±F and 1±G, the air-fuel-ratio correction factor FAF belongs to a region II; and when the air-fuel-ratio correction factor FAF is outside 1±G, the air-fuel-ratio correction factor FAF belongs to a region III. Here, it is assumed that 0<F<G.

When it is determined in step 9063 that the air-fuel-ratio correction factor FAF belongs to the region I, the routine proceeds to step 9064 in which a purge ratio PGR is increased by a previously determined purge ratio increase amount D and then the routine proceeds to step 9066. When it is determined in step 9063 that the air-fuel-ratio correction factor FAF belongs to the region III, the routine proceeds to step 9065 in which a purge ratio PGR is decreased by a previously determined purge ratio decrease amount E and then the routine proceeds to step 9066. When it is determined in step 9063 that the air-fuel-ratio correction factor FAF belongs to the region II, the routine proceeds directly to step 9066.

In step 9066, the purge ratio PGRcomp to be corrected at the time of restarting purge, which will be described later, is subtracted from the purge ratio PGR and the routine proceeds to step 9067. In step 9067, a previously determined value F is subtracted from the purge ratio PGRcomp to be corrected at the time of restarting purge and it is determined in step 9068 whether or not the purge ratio PGRcomp to be corrected at the time of restarting purge is positive.

When determination in step 9068 is negative, the purge ratio PGRcomp to be corrected at the time of restarting purge is set at a lower limit “0” in step 9069 and the routine proceeds to step 9070. When determination in step 9068 is affirmative, the routine proceeds directly to step 9070 in which the purge ration PGR is checked against the upper and lower limits thereof and this routine is finished.

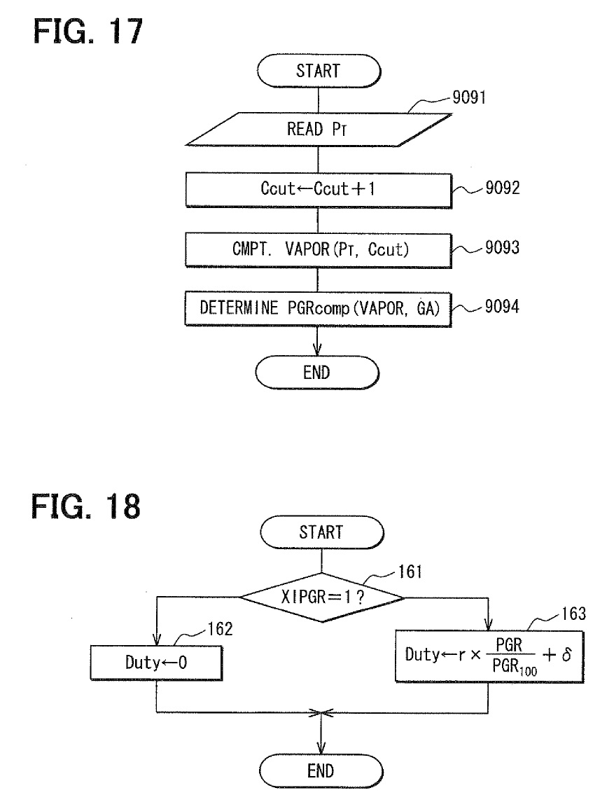

FIG. 17 is a flowchart of processing of computing a purge ratio to be corrected at the time of restarting purge which is executed in step 909 of the purge ratio control routine shown in FIG. 10. First, in step 9091, a pressure PT in the fuel tank is detected by a pressure sensor (not shown) provided in the fuel tank 11. The pressure PT in the fuel tank is a function of the fuel vapor quantity in the fuel tank 11, and the fuel vapor quantity in the fuel tank 11 expresses the state of balance between the evaporation of the fuel and the dissipation of the fuel into the canister 13 and the liquefaction of the fuel vapor, so the pressure PT in the fuel tank expresses the degree of evaporation of the fuel in the fuel tank 11. Here, the degree of evaporation of the fuel is roughly determined by fuel temperature and pressure applied to the surface of the fuel, so fuel temperature may be used as a factor expressing the degree of evaporation of the fuel in place of the pressure PT in the fuel tank. When the pressure PT in the fuel tank is used as a parameter, effects of a change in the atmospheric pressure and the like are cancelled and hence more correct measurement can be performed.

In the next step 9092, the fuel cut counter Ccut is incremented by one and the routine proceeds step 9093. Here, the fuel cut counter Ccut expresses the time during which the state of fuel cut continues. In step 9093, an fuel vapor quantity VAPOR (PT, Ccut) absorbed by the canister 14 during the fuel cut is found as a function of the pressure PT in the fuel tank and the fuel cut counter Ccut.

As a function for finding the fuel vapor quantity VAPOR can be used, for example, the following function. That is, a fuel evaporation quantity α(PT) per unit time can be determined as a function of the pressure PT in the fuel tank, so the fuel vapor quantity VAPOR can be found by the following equation of multiplying the fuel evaporation quantity α(PT) per unit time by the count value of the fuel cut count Ccut.
VAPOR=α(PT)·Ccut

In step 9094, the purge ratio PGRcomp to be corrected at the time of restarting purge is computed, which is determined as a function of the fuel vapor quantity and an intake air volume GA detected by the air flow sensor.
PGRcomp=β·VAPOR/GA

where b is a factor.

FIG. 18 is a flowchart of a purge control valve drive routine and the opening of the purge valve 16 is controlled by the so-called duty ratio control. That is, it is determined in step 161 whether or not a purge stop flag XIPGR is “1”. When determination is affirmative, it is determined that purge is stopped and a duty ratio Duty is set at 0 in step 162, and this routine is finished.

When determination in step 161 is negative, it is assumed that purge is being performed and the routine proceeds to step 163 in which a duty ratio Duty is computed by the following equation.
Duty=γ·PGR/PGR100+δ,

where PGR100 is a fully-open purge ratio and expresses the purge quantity when the purge valve 16 is fully opened.

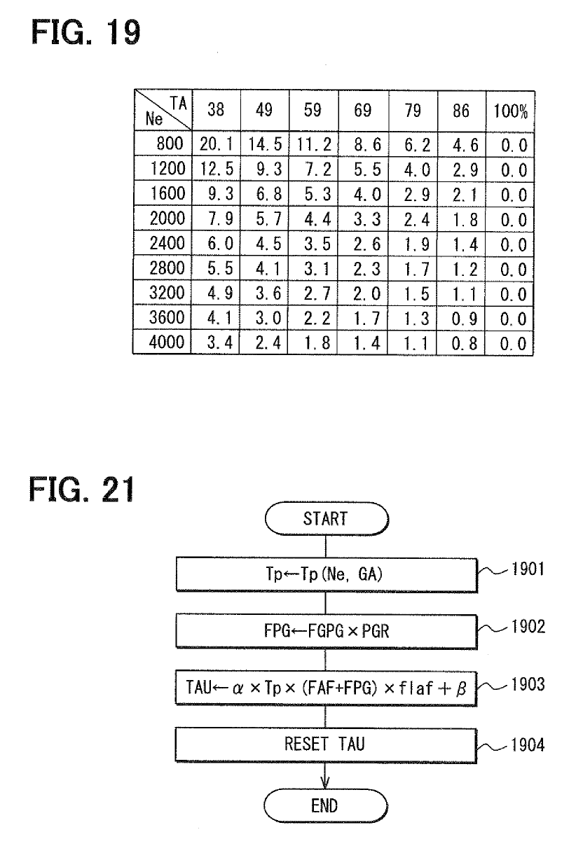

This fully-open purge ratio PGR100 is previously set as a map of an engine speed Ne and a throttle valve opening TA. FIG. 19 is an example of a set map for determining the fully-open purge ratio PGR100. g and d are correction factors determined by a battery voltage and the atmospheric pressure.

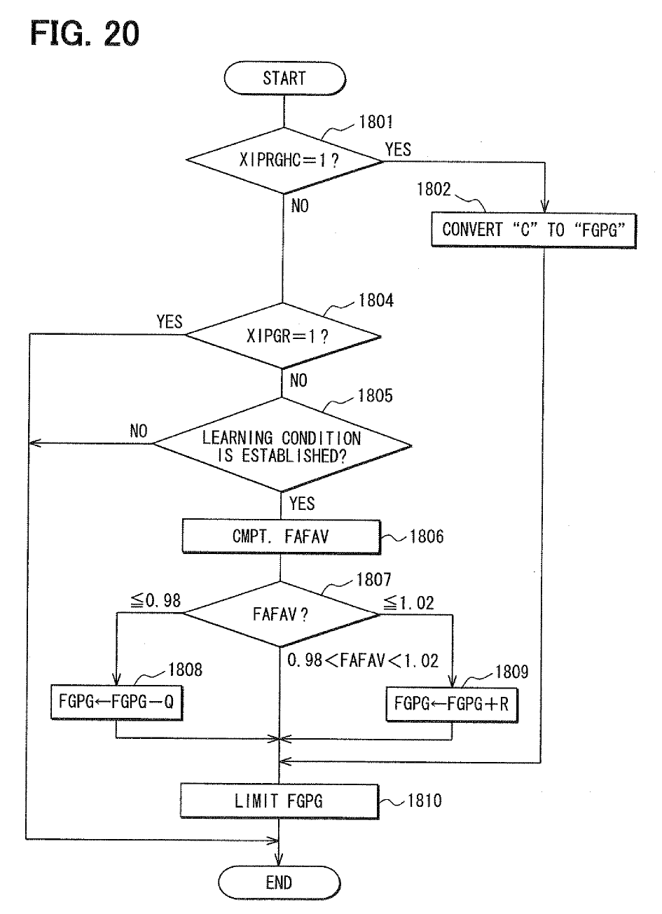

FIG. 20 is a flowchart of a fuel concentration learning routine for computing a fuel concentration FGPG. In step 1801, it is determined whether or not a pressure concentration detection completion flag XIPRGHC is 1. When determination in step 1801 is affirmative, step 1802 corresponding to concentration conversion means is executed. In step 1802, by substituting the fuel concentration C determined in FIG. 7 into the following equation, the fuel concentration C is converted to a fuel concentration FGPG expressing such a relative fuel vapor concentration of purge gas as is compared with a theoretical air-fuel-ratio (=14.6) of a target air-fuel-ratio.
FGPG=(1−C)−(14.6×C×density of fuel vapor/density of air)

Here, the density of fuel vapor and the density of air may be replaced by a previously determined constant values or may be determined on the basis of temperature.

When the ratio of fuel vapor to purge gas is the same as that of an air-fuel mixture of a stoichiometric air-fuel-ratio, the above-mentioned fuel concentration FGPG becomes 0. When the ratio of fuel vapor to purge gas is larger than the theoretical air-fuel-ratio, the fuel concentration FGPG becomes minus. Moreover, when the ratio of fuel vapor to purge gas is smaller than the theoretical air-fuel-ratio, the fuel concentration FGPG becomes plus. Further, when the purge gas does not contain evaporated gas, the fuel concentration FGPG becomes 1. Hence, it can also be said that the fuel concentration FGPG expresses the degree of deviation from the stoichiometric air-fuel-ratio of the purge gas.

In step 1803, a pressure concentration detection completion flag XIPRGHC is reset to 0. And the procedure advances to step 1810.

When determination in step 1801 is negative, the routine proceeds to step 1804 in which it is determined whether or not the purge stop flag XIPGR is “1”. When determination is affirmative, it is assumed that purge is stopped and directly this routine is finished.

When determination in step 1804 is affirmative, the routine proceeds to step 1805 in which it is determined whether or not fuel concentration learning conditions are satisfied. That is, when all of conditions that:

(1) air-fuel feedback control is being performed,

(2) cooling water temperature 80° C.,

(3) fuel increase quantity at the startup=0, and

(4) fuel increase quantity at warm-up=0 are satisfied, learning is performed, and when any one of the conditions is not satisfied, learning is not performed.

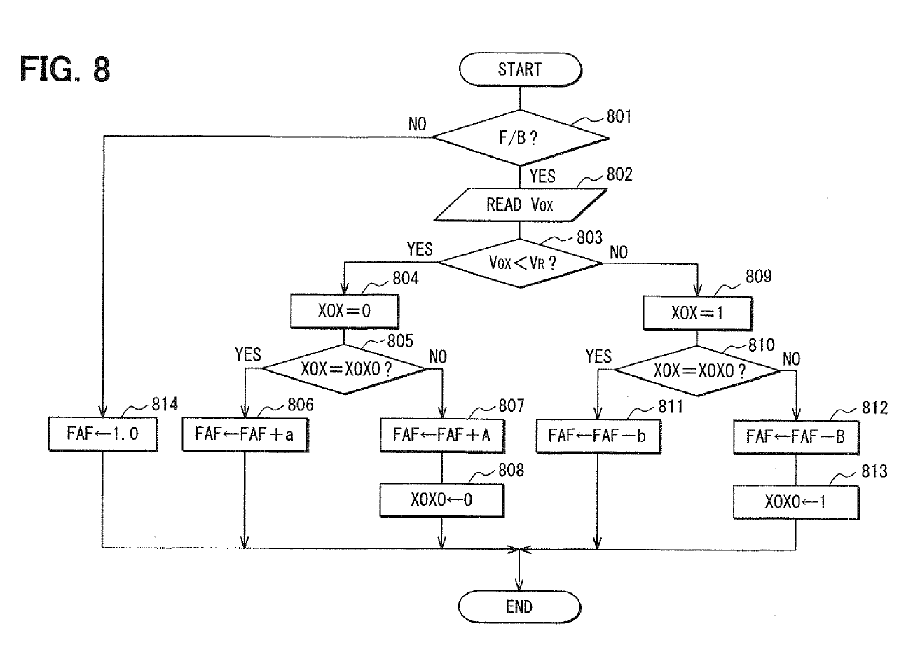

When determination in step 1805 is negative, that is, learning is not performed, this routine is finished directly. When determination in step 1805 is affirmative, that is, learning is performed, the routine proceeds to step 1806. In step 1806, the time average value FAFAV of the air-fuel-ratio correction factor FAF computed by the air-fuel-ratio control routine in FIG. 8 is computed and the routine proceeds to step 1807.

In step 1807, it is determined which of regions of 0.98 or less, more than 0.98 and less than 1.02, and 1.02 or more the average value FAFV belongs to. When it is determined that the average value FAFV is 0.98 or less, the routine proceeds to step 1808 in which the fuel concentration FGPG is decreased by a specified amount “Q” (for example, 0.4%) and the routine proceeds to step 1810.

When it is determined that the average value FAFV is 1.02 or more, the routine proceeds to step 1809 in which the fuel concentration FGPG is increased by a specified amount “P” (for example, 0.4%) and the routine proceeds to step 1810. When it is determined that the average value FAFV is more than 0.98 and less than 1.02, the fuel concentration FGPG is not updated but the routine directly proceeds to step 1810. The fuel concentration FGPG determined in step 1809 corresponds to a first fuel concentration.

In this regard, when the fuel vapor concentration of purge gas is “0”, the fuel concentration FGPG determined by executing step 1808 or step 1809 is set at “1”, and as the fuel concentration becomes larger, the fuel concentration FGPG becomes a value smaller than 1. In step 1810, the fuel concentration FGPG is limited to a value within specified upper and lower values and this routine is finished.

FIG. 21 is a flowchart of an injector control routine. First, in step 1901, a base fuel injection time Tp is found as a function of an engine speed Ne and an intake air volume GA.
Tp=Tp(Ne,GA)

In the next step 1902, a purge correction factor FPG is computed on the purge ratio PGR and the fuel concentration FGPG determined in FIG. 20.
FPG=(FGPG−1)·PGR

In step 1903, an injector valve opening time TAU is determined by the following equation using the air-fuel-ratio correction factor FAF computed by the air-fuel-ratio control routine shown in FIG. 8, the purge correction factor FPG, and a learning correction value “flaf”.
TAU=α·Tp·(FAF+FPG)·Flaf+β

where α and β are correction factors including a warm-up increase amount and a startup increase amount.

In step 1904, the injector valve opening time TAU is outputted and this routine is finished.

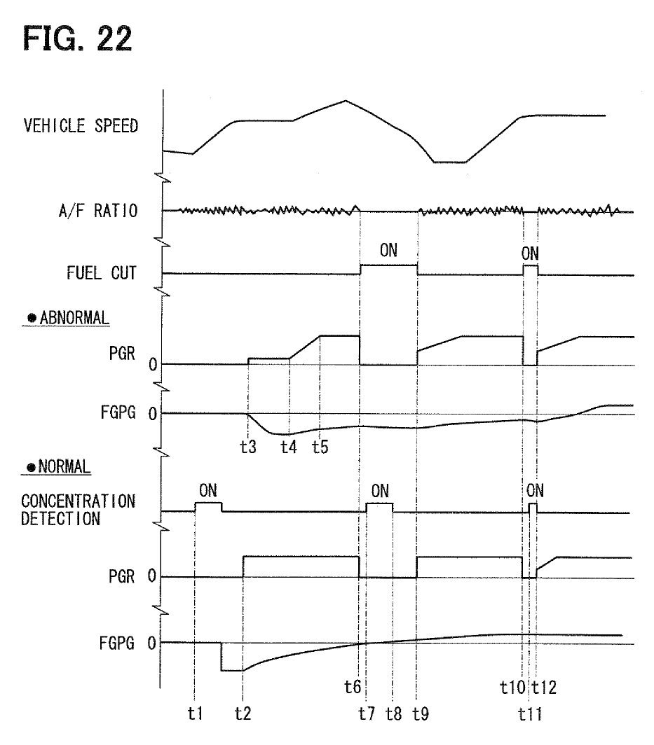

FIG. 22 is a time chart showing a purge timing when abnormality diagnosis conditions are satisfied while the engine is stopped, abnormality diagnosis control (FIG. 2) is performed in advance. An example of a time chart when the diagnosis result is abnormal and normal is shown in FIG. 22.

If the diagnosis result is normal, when determinations in steps 601 to 603 in FIG. 6 are affirmative, for example, when the ignition switch is turned on, the detection of fuel concentration based on pressure measurement (FIG. 7) is started (timing t1).

When the detection of fuel concentration in FIG. 7 is finished to acquire a fuel concentration C, the fuel concentration C can be converted to the relative fuel vapor concentration, that is, the fuel concentration FGPG in step 1802 in FIG. 20. Moreover, the pressure concentration detection completion flag XIPRGHC becomes 1, so purge ratio initial value determination processing in step 9062 in FIG. 12 is performed. For this reason, the purge ratio is brought to a large purge ratio PGR determined by performing the purge ratio initial value determination processing and then purge is started (timing t2).

On the other hand, when the diagnosis result is abnormal, purge is started at as small a purge ratio PGR as does not affects the air-fuel-ratio (timing t3). A fuel concentration FGPG when the purge ratio PGR is further enlarged from this small purge ratio PGR is predicted. Further, from after the prediction is completed (timing t4), the purge valve 16 is gradually opened while the fuel concentration FGPG is repeatedly learned on the basis of the predicted values, and at timing t5, the purge ratio PGR reaches a maximum value. With this, even if the fuel concentration FGPG cannot be known before starting purge, it is possible to perform purge while preventing the air-fuel-ratio being disturbed.

When the vehicle speed is brought to a state of deceleration to bring about a state in which fuel cut is ON (timing t6), the purge ratio PGR is brought to 0, that is, there is brought about a state in which the purge valve 16 is totally closed to interrupt purge. When a specified period of time elapses in a state of interrupting purge after the last detection of the fuel concentration based on pressure measurement is completed, in a case where the diagnosis result is normal, all of determinations in steps 601 to 604 in FIG. 6 become affirmative, so the detection of the fuel concentration based on pressure measurement is started again (timing t7). When the detection of the fuel concentration is completed at timing t8, the pressure concentration detection completion flag XIPRGHC is set at 1 in step 902 in FIG. 10 and the fuel concentration FGPG is computed in step 1802 in FIG. 20.

When there is brought about a state in which fuel cut is OFF, that is, when fuel cut is released at timing t9 after timing t8, the fuel concentration FGPG is computed in step 1802 in FIG. 20, so purge is started again at a large purge ratio PGR from the time when purge is started again (timing t9).

On the other hand, in a case where the diagnosis result is abnormal, purge is started again at a purge ratio PGR determined on the basis of a period of time during which fuel cut is ON. With this, purge can be started again without disturbing the air-fuel-ratio. After purge is started again, the fuel concentration FGPG is learned repeatedly and at the same time the purge ratio PGR is increased.

Moreover, when the fuel cut is rendered ON at timing t10 and the detection of fuel concentration based on pressure measurement is started at timing t11 and the fuel cut is rendered OFF at timing t12 without the detection of fuel concentration being completed, even in a case where the diagnosis result is normal, as is the case where the diagnosis result is abnormal, purge is started again at a purge ratio PGR determined by integrating the period of time during which the fuel cut is ON.

Thus, in this embodiment, in a case where the fuel concentration detection system is normal, purge can be started at the maximum purge ratio PGR from the time when purge is started (timing t2), and the purge ratio PGR can be set at the maximum purge ratio PGR also when purge is started again (timing t9). Thus, the amount of purge can be increased sufficiently.

Moreover, in a case where the detection of fuel concentration is not completed in the course of interrupting purge, the purge ratio PGR when purge is started again is determined on the basis of the period of time during which purge is interrupted, so even if the detection of fuel concentration is not completed in the course of interrupting purge, the purge ratio PGR when purge is started again can be increased to some extent. This can also increase the amount of purge.

In addition, in a case where it is diagnosed in the abnormality diagnosis control in FIG. 2 that the fuel concentration detection system is abnormal, the detection of fuel concentration by that fuel concentration detection system (FIG. 7) is not performed but the fuel concentration FGPG (first fuel concentration) determined on the basis of the amount of deviation from the target air-fuel-ratio of the air-fuel-ratio in FIG. 8 is used irrespective of the operating state of the vehicle, so it is also possible to prevent that the fuel injection quantity is controlled on the basis of the abnormal fuel concentration to deviate the air-fuel-ratio from the target air-fuel-ratio.

Furthermore, in this embodiment, when the history of the abnormality diagnosis shown in FIG. 2 is normal determination history, since fuel injection quantity is controlled using the air-fuel-ratio earning “flaf” in the past trip based on the normal determination history so that the air-fuel-ratio turns into the target air fuel ratio even if it is the case where air-fuel-ratio learning has not been completed yet on this trip. Hence, even if it is in the condition (T1 (40° C.)≦(THW)≦T2 (80° C.)) after the cold-start in which the air-fuel-ratio learning start condition on this trip is not established, the purge initiation timing t2 can be brought forward by purge control execution determination of FIG. 11 (t2<t3).

The preferred embodiment is described above. The present invention is not limited to the above embodiment.

For example, the closed volume for performing the abnormality diagnosis is formed when the purge valves 16 is closed, the three position valve 21 is in the second position, and the switching valve 18 is in the second position in the above embodiment. The closed volume should just include a path for which the air-fuel mixture circulates in the fuel concentration detection (FIG. 7). In this case, it can be determined that there is a possibility that the air-fuel-mixture pressure P1 cannot be measured correctly when the abnormalities exist in the closed volume. Therefore, for example, although the purge valve 16 and the switching valve 18 are still the above-mentioned embodiments, the closed volume can be defined by making the three-position valve 21 into the third position. Moreover, the three-position valve 21 is made into the second position and the switching valve is in the first position for defining the closed volume.

Moreover, it is also recommendable to diagnose an abnormality in the fuel concentration detection system on the basis of the pressure P when the closed space is formed and of whether or not the pressure P is decreased to a predetermined determination value or less. This is because when the pressure P is not decreased to the determination value or less, it can be thought that abnormalities such as a decrease in the capacity of the pump 26, a faulty switching operation of the switching valve 18 and the three-position valve 21, and a leak occur.

Further, it is also recommendable to provide a position sensor for detecting the positions of the switching valve 18 and the three-position valve 21 and to diagnose an abnormality in the switching valve 18 and the three-position valve 21 on the basis of a signal from the position sensor.

In the above-mentioned embodiment, the pressure sensor 24 has its one end connected to the downstream side of the orifice 23 and has its other end opened to the atmosphere. However, it is also recommendable to detect a differential pressure across the orifice 23 by connecting the other end of the pressure sensor 24 to the upstream side of the orifice 23.

Moreover, in the embodiment mentioned above, although the three-position valve 21 is used, it is possible to adopt a plurality of two-position valves.

What is claimed is:

1. A fuel vapor treatment system for an internal combustion engine, comprising
a canister that temporarily adsorbs a fuel vapor developed in a fuel tank;
a purge pipe that introduces the fuel vapor purged from the canister into an intake pipe of the internal combustion engine;
a purge control valve that is arranged in the purge pipe and controls a purge flow rate from the purge pipe to the intake pipe;
an air-fuel-ratio sensor that is provided in an exhaust pipe of the internal combustion engine and measures an air-fuel-ratio;
a first fuel state determination means that determines a state of fuel of an air-fuel mixture containing the fuel vapor purged from the canister on the basis of an amount of deviation from a target air-fuel-ratio of an air-fuel-ratio detected by the air-fuel-ratio sensor when the purge control valve is opened; and
an air-fuel-ratio learning means which performs an air-fuel-ratio learning for correcting an air-fuel-ratio deviations between an air-fuel-ratio detected by the air-fuel-ratio sensor and a target air fuel ratio when the purge control valve is closed,
an air-fuel-ratio control means that controls a fuel injection quantity to the internal combustion engine, which is corrected based on a learning correction quantity determined by the air-fuel-ratio learning means, in such a manner as to bring an air-fuel-ratio to the target air-fuel-ratio on the basis of the state of fuel of the air-fuel mixture purged from the canister;
a second fuel state determination means that determines the state of fuel of the air-fuel mixture purged from the canister when the purge control valve is closed;
an abnormality detection means for detecting an abnormalities of the second fuel state determination means;
a first memory means for storing a history of the abnormality detection of the second fuel state determination means by the abnormality detection means;
a second memory means for storing a learning history of air-fuel-ratio learning by the air-fuel-ratio learning means; and
a purge timing variable means which variably adjusts the start timing of the purge with the purge control valve based on the history of the abnormality detection of the second fuel state determination means and the learning history of the air-fuel-ratio learning means.

2. A fuel vapor treatment system for an internal combustion engine according to claim 1, wherein
when the history of the abnormality detection of the second fuel state determination means by the first memory means is a normal determination history which represents no abnormality detection, and when the learning history of the air-fuel-ratio learning means by the second memory means is a completion history which represents that the learning is completed in the last vehicle operation condition, the purge control timing variable means establishes a initiation timing of the purge by the purge control valve after cold-start of the internal combustion engine in the vehicle operation condition, and
when the fuel injection quantity by the air-fuel-ratio-control means is executed, the purge control timing variable means executes the purge control.

3. A fuel vapor treatment system for an internal combustion engine according to claim 2, wherein
the air-fuel-ratio-control means controls the fuel injection quantity based on the learning correction quantity stored in the completion history in a previous vehicle-operation-condition.

4. A fuel vapor treatment system for an internal combustion engine according to claim 1, wherein
the purge control timing variable means stops the purge control and performs air-fuel-ratio learning by the air-fuel-ratio learning means when the internal combustion engine is in warm-up.

5. A fuel vapor treatment system of an internal combustion engine according to claim 1, wherein
the air-fuel-ratio-control means controls the fuel injection quantity based on the fuel condition determined by the first fuel state determination means or the fuel condition determined by the second fuel state determination means according to the vehicle operation condition, when the abnormalities are not detected by the malfunction detection means, and
the air-fuel-ratio-control means controls the fuel injection quantity irrespective of the vehicle operation condition based on the fuel condition determined by the first fuel state determination means, when the abnormalities are detected by the abnormality detection means.

6. A fuel vapor treatment system for an internal combustion engine according to claim 1, wherein
when the abnormalities are not detected by the abnormality detection means and when it is before a start of the purge control, the air-fuel-ratio-control means controls the fuel injection quantity based on the fuel condition determined by the second fuel state determination means.

7. A fuel vapor treatment system for an internal combustion engine according to claim 1, wherein
when it is after the start of the purge control and the purge control is not suspended, the air-fuel-ratio-control means controls the fuel injection quantity based on the fuel condition determined by the first fuel state determination means.

8. A fuel vapor treatment system for an internal combustion engine according to claim 1,
when the abnormalities are not detected by the abnormality detection means and the purge is suspended, the air-fuel-ratio-control means controls the fuel injection quantity based on the fuel condition determined by the second fuel state determination means.

9. A fuel vapor treatment system for an internal combustion engine according to claim 8, wherein
when the purge is suspended and when the determination of the fuel condition by second fuel state determination means is uncompleted, the air-fuel-ratio-control means controls fuel injection quantity based on the fuel concentration determined by the first fuel state determination means just before purge suspension.

10. A fuel vapor treatment system for an internal combustion engine according to claim 1, wherein
the second fuel state determination means includes
a measurement passage which has an orifice;
a pump which generates a gas stream flowing through the orifice;
a pressure measuring means for measuring a quantity of pressure drops produced by the orifice when the pump generates the gas stream, and
a switching means which switches the measurement passage between a first measurement condition and a second measurement condition,
in the state of the first measurement, the switching means opens the measurement passage to the atmosphere, and the air flows through the measurement passage,
in the state of the second measurement, the measurement passage communicates with the canister while the purge control valve is closed, and the air-fuel mixture containing the fuel vapor from the canister flows through the measurement passage,
the second fuel state determination means determines the fuel condition based on the first pressure measured by the pressure measuring means in the first measurement condition, and the second pressure measured by the pressure measuring means in the second measurement condition, and
the abnormality detection means detects the at least one abnormality of the measurement passage, the pump, the pressure measuring means, and the switching means.

11. The fuel vapor treatment system for an internal combustion engine according to claim 10, further comprising:
a closed volume formation valve for defining a closed volume in at least a part of a fuel condition detection system which includes the measurement passage, the pump, the pressure measuring means, and the switching means,
a leakage detection passage of which one end is opened to the atmosphere and which includes the orifice;
the pressure applying means which pressurizes or decompresses the closed volume and an interior of the leakage detection passage,
a pressure measuring means which measures the pressure in the closed volume or the leakage inspection passage pressurized or decompressed by the pressure applying means, and
a pressure impression range switching means which changes the pressure impression range pressurized or decompressed by the pressure applying means to either of the two kinds of leakage measurement conditions that the pressure impression range differs mutually including at least one of the closed volume and the leakage detection passage, wherein
the abnormality detection means detects the abnormalities of the fuel condition detection system based on the comparison of the two pressures measured by the pressure measuring means in the two kinds of leakage measurement conditions.

12. A fuel vapor treatment system for an internal combustion engine according to claim 11, wherein
the leakage detection passage is the measurement passage.

13. A fuel vapor treatment system for an internal combustion engine according to claim 12, wherein
the pressure impression range switching means is the switching means.

14. A fuel vapor treatment system for an internal combustion engine according to claim 11, wherein
the pressure applying means is the pump which generates the gas stream in the measurement passage.
